(19) United States
(12) Patent Application Publication
(10) Pub. No.: US 2025/0363327 A1
(43) Pub. Date: Nov. 27, 2025

(54) System and Method for Utilizing a Large Language Model (LLM) to Automatically Construct a Machine Learning (ML) Classification Model

(71) Applicant: VARONIS SYSTEMS, INC., New York, NY (US)

(72) Inventors: Amit Osi, Tel Aviv (IL); Ron Sneh, Atlit (IL)

(21) Appl. No.: 18/670,752

(22) Filed: May 22, 2024

(51) Int. Cl. G06N 3/042

(52) U.S. Cl. CPC G06N 3/042

(57) ABSTRACT

A computerized method includes: obtaining a first dataset of pre-labeled textual items, wherein each pre-labeled textual item is associated with a pre-label; feeding each of the pre-labeled textual items into a Large Language Model (LLM), and prompting it to generate textual reasoning that supports the pre-label of each pre-labeled textual item; collating the generated textual reasonings, and generating therefrom a textual instruction prompt; obtaining a second dataset of not-yet-labeled textual items; feeding each of the not-yet-labeled textual items into the LLM, and commanding it to utilize the textual instruction prompt and to generate a textual label for each of the not-yet-labeled textual items; collecting those textual items, that were labeled by the LLM, into a third dataset of LLM-labeled textual items; automatically training a Machine Language (ML) classification model on that third dataset of LLM-labeled textual items; deploying that ML classification model in a platform for classification of textual items.

### FIELD

Some embodiments are related to the field of computerized systems.

### BACKGROUND

A large corporation, organization, or other entity may have thousands of team-members who utilize computing devices for various purposes; for example, to send and receive electronic mail, to engage in video calls, to browse the Internet, to compose documents, to access data repositories, to prepare presentations, to manage projects, or the like.

Team-members of a large organization may cumulatively produce, edit, send and/or receive thousands of documents or messages per day or even per hour.

### SUMMARY

Some embodiments include systems and methods for utilizing a Large Language Model (LLM) to automatically construct a Machine Learning (ML) classification model. For example, pre-labeled (pre-classified, pre-tagged) textual items are fed into the LLM, which is prompted to generate textual reasonings that support the pre-labeling of each such textual item. The plurality of textual reasonings are collected or collated into a Unified List of classification indicators/features, and the LLM generates from that Unified List an Instruction Prompt. A dataset of not-yet-labeled textual items is then fed into the LLM, with the Instruction Prompt; to generate database of LLM-based classified textual items; which is then utilized to automatically train a Machine Learning (ML) classification model, which can then be deployed online and/or offline. The system may be configured to perform binary classification of textual items, or multi-class classification of textual items.

For example, a computerized method includes: obtaining a first dataset of pre-labeled textual items, wherein each pre-labeled textual item is associated with a pre-label; feeding each of the pre-labeled textual items into a Large Language Model (LLM), and prompting it to generate textual reasoning that supports the pre-label of each pre-labeled textual item; collating the generated textual reasonings, and generating therefrom a textual instruction prompt; obtaining a second dataset of not-yet-labeled textual items; feeding each of the not-yet-labeled textual items into the LLM, and commanding it to utilize the textual instruction prompt and to generate a textual label for each of the not-yet-labeled textual items; collecting those textual items, that were labeled by the LLM, into a third dataset of LLM-labeled textual items; automatically training a Machine Language (ML) classification model on that third dataset of LLM-labeled textual items; deploying that ML classification model in a platform for classification of textual items.

Some embodiments may provide other and/or additional benefits and/or advantages.

### BRIEF DESCRIPTION OF THE DRAWINGS

FIG. 1 is a flow-chart of a computerized method, in accordance with some demonstrative embodiments.

FIG. 2 is a flow-chart of a computerized method, in accordance with some demonstrative embodiments.

FIG. 3 is a schematic block-diagram illustration of a computerized system, in accordance with some demonstrative embodiments.

### DETAILED DESCRIPTION OF SOME DEMONSTRATIVE EMBODIMENTS

Some embodiments provide systems and methods that enable efficient binary classification (e.g., classification of a data-item or data-point or message or document) into one of two possible classes or categories) or multiple-class/multi-class classification (e.g., classification of a data-item or data-point or message or document into one of a plurality of categories); and particularly, while utilizing and leveraging a Large Language Model (LLM) to generate and to provide textual reasoning/textual explanation that supports or explains each such classification.

The Applicant has realized that some computerized systems may utilize and apply various classification models for different applications, and particularly to perform binary classification or multiple-class classification of a particular message or document or file. For example, realized the Applicant, some computerized systems and cyber-security systems attempt to classify an incoming message as being “spam” or “non-spam”, or as being “phishing” or “non-phishing”, or as being “legitimate” or “fraudulent/fraud-related”, including email security (spam, phishing) and document classification (multiclass task). Similarly, realized the Applicant, some computerized systems attempt to classify a document as “containing Personally Identifiable Information (PII)” or “not containing PII”; or to classify an incoming message as “requires urgent attention” or “does not require urgent attention”; or the like.

The Applicant has realized that some conventional classification models—particularly those that utilize Machine Learning (ML) for classification—may provide useful classifications in some implementations, such conventional models typically do not provide and do not generate any clear/understandable/textual/human-readable explanation about the reasons or reasoning for the particular classification of a particular document or message, or other clear/understandable/human-readable textual support for classification decisions. The Applicant has realized that this shortcoming of conventional systems is particularly true when complex data types are involved, such as in systems that classify text or text-portions or text-segments or textual messages or textual documents; and conventional model classification or even interpretation methods do not provide any insights, or sufficient insights, with regard to the reasoning that based the classification results.

Some embodiments of the present invention address, prevent or mitigate these problems or shortcoming of conventional systems, by providing computerized systems and computerized methods that both (I) perform a binary or multi-class classification of a data-item/data-point/document/textual message, and also (II) generates textual and human-readable (e.g., expressed in a natural language, such as English) explanation or explanatory reasoning that support the classification decision with regard to each such particular data-item/data-point/document/textual message. Some embodiments utilize and leverage an Artificial Intelligence (AI) model, and particularly a Large Language Model (LLM), to extract or recognize or deduce or infer one or more indicators or features from labeled data, and enable the system to use these indicators or features to generate a textual explanation of for classification of new, un-labeled or not-yet-labeled data-items/documents/messages.

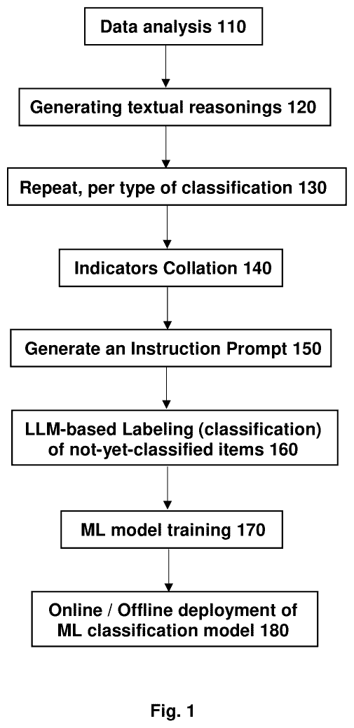

Reference is made to FIG. 1, which is a flow-chart of a computerized method in accordance with some demonstrative embodiments.

As indicated in block 110, data analysis is performed, such that an LLM analyzes a set of already-labeled data-items. For example, a set of documents or messages are fed into the LLM, each document/message being already pre-labeled as “spam”/“non-spam”, or as “phishing”/“non-phishing”, or as “legitimate”/“fraud-related”, or as “contains PII”/“not containing PII”, or as “requires urgent attention”/“non-urgent”. A variety of other classifications may be used; for example, is the document (or message) related to (or relevant to) the Legal department, or not; is the document (or message) related to (or relevant to) the Finance department, or not; is the document (or message) related to (or relevant to) the Human Resources department, or not; is the document (or message) related to (or relevant to) the Information Technology (IT) department, or not; or the like.

As indicated in block 120, the LLM is prompted or commanded or instructed to identify/deduce/infer/generate textual reason(s) that support the pre-labeled classification of each of those pre-labeled documents/messages. For example, the LLM may be prompted, “Please perform textual analysis of each message, and generate a detailed textual explanation of the reasoning that supports the pre-labeled classification of each of those messages”. For example, the LLM may be fed the set of pre-labeled spam/non-spam messages, and may be prompted to “Generate a textual explanation in a natural language, that supports the classification of each of these messages as either spam or non-spam”. In this process, the LLM receives Message-1, and generates for it Supporting-Reasoning-1; the LLM receives Message-2, and generates for it Supporting-Reasoning-2; the LLM receives Message-3, and generates for it Supporting-Reasoning-3; and so forth. In some implementations, these operations may be performed in series or consecutively, such that a single LLM is fed those pre-labeled messages, one message after the other, and is prompted to generate the reasoning text for the classification of each message; whereas, in other implementations, the plurality of pre-labeled messages may be fed in parallel to two or more LLMs, for parallel processing and for parallel generation of the reasoning text for the classification of each messages. The result of these operations is a set of pairs of data-items, such as: Message-1=>Reason-1, Message-2=>Reason-2, Message-3=>Reason-3, and so forth.

As indicated in block 130, these operations may optionally be repeated for each class or for each category. For example, the LLM may be prompted to generate textual reasoning for the classification of each of the pre-labeled messages as “spam”/“non-spam”; and, the LLM may be prompted to generate textual reasoning for the classification of each of the pre-labeled messages as “urgent”/“non-urgent”; and, to generate textual reasoning for the classification of each of the pre-labeled messages as “contains PII”/“does not contain PII”; and so forth, for a plurality of classes or categories. In some implementations, this may be performed serially or consecutively, such that a single LLM analyzes each pre-labeled message to generate the supporting reasoning for Classification A (e.g., spam or non-spam), and then the LLM analyzes each pre-labeled message to generate the supporting reasoning for Classification B (e.g., urgent or non-urgent), and then the LLM analyzes each pre-labeled message to generate the supporting reasoning for Classification C (e.g., legitimate or fraud-related), and so forth. In other implementations, the LLM may generate the supporting reasoning for each message across a plurality of classes, before continuing to analyze the next pre-labeled message; for example, the LLM is fed pre-labeled Message-1, and is prompted to generate Spam-Reasoning-1 that explains why Message-1 is spam or non-spam, and is prompted to also generate Urgent-Reasoning-1 that explains why Message-1 is urgent or non-urgent, and is prompted to generated PII-Reasoning-1 that explains why Message-1 contains PII or does not contain PII; and then, the LLM is fed the next pre-labeled message, which is Message-2, and is prompted to generates the reasonings for that Message-2 (namely, to generate Spam-Reasoning-2, and Urgent-Reasoning-2, and PII-Reasoning-2); and then to process Message-3, and so forth.

Optionally, in still other implementations, a plurality of LLMs may be used, in series and/or in parallel, to generate the reasonings for the classifications of the pre-labeled messages into the various categories or classes; for example, LLM-1 generates the reasonings that support the classification of each message as spam/non-spam,; whereas LLM-2 generates (in parallel to LLM-1, or at a different time) the reasonings that support the classification of each message as urgent/non-urgent; whereas LLM-3 generates (in parallel to LLM-1 and/or LLM-2, or at a different time) the reasonings that support the classification of each message as contains PII/does not contain PII. In some implementations, each such LLM may be trained or pre-trained or configures to have particular capability with regard to a particular type of classifications, in order to improve the quality of the outputs of those LLMs.

As indicated in block 140, indicator collation is performed. For example, the reasonings that were generated by the LLM(s), that explain and support the classification of documents/messages into classes, are collected and are fed back into the same LLM or a different LLM, which is now prompted or commanded to distill and process these various reasons (for each classification) and to generate Unified List of indicators or features that characterize a particular class or category. Each such Unified List, per class or per category of classification, can be utilized as a set of rules or guidelines or conditions that are associated by the LLM with each such category or class. The indicators collection/collation is performed per class, or per category.

For example, the set of LLM-generated reasonings that explain why each pre-labeled message is spam or non-spam, namely, Spam-Reasoning-1 and Spam-Reasoning-2 and Spam-Reasoning-3 and so forth, is fed into an LLM that generates a Unified List of reasons for classifying a message as spam/non-spam. Similarly, the set of LLM-generated reasonings that explain why each pre-labeled message is urgent or non-urgent, namely, Urgent-Reasoning-1 and Urgent-Reasoning-2 and Urgent-Reasoning-3 and so forth, is fed into an LLM that generates a Unified List of reasons for classifying a message as urgent/non-urgent. This is repeated for each set of reasonings, for each classification; and can be done by a single LLM or by several LLMs, and can be done in series and/or in parallel.

As indicated in block 150, an Instruction Prompt is generated, per each Unified List of indicators that were generated as described above. For example, the instruction prompt for the indicator of “spam/non-spam”, may be: “Classify the message as Spam if Indicator-1 exists, or if Indicator-2 exists, or if Indicator-3 exists”. In some implementations, the instruction prompt may optionally include a mixture of positive and negative conditions; such as, “Classify the message as Spam if Indicator-1 exists, or if Indicator-2 does not exist, or if Indicator-3 exists”. In some embodiments, the instruction prompt may include one or more Boolean operators, such as AND, OR, NOT, or other logic elements.

As indicated in block 160, each message/document (or other type of textual item) in a non-labeled dataset of messages/documents, can now be automatically labeled (or classified, or categorized, or tagged) by an LLM by using the Instruction Prompt that was automatically generated as mentioned above. For example, the LLM may be fed a non-labeled message/document, and may be fed (e.g., as context) the relevant Instruction Prompt, and may be prompted to label/tag/classify that non-labeled message or document. In a first example, the Instruction Prompt with regard to spam/non-spam classification, is fed into the LLM; and the LLM is prompted to classify a new, not-yet-labeled, message/document as spam/non-spam based on that Instruction Prompt; and this is repeated (in series and/or in parallel) with regard to a plurality of non-labeled messages/documents, to thus generate a dataset of labeled messages/documents that the LLM classified as spam or non-spam. Similarly, a dataset of non-labeled documents may be automatically labeled or tagged by the LLM, using the relevant Instruction Prompt, as being urgent or non-urgent, or as being HR-related or not, or as being Finance-related or not, or the like.

Some demonstrative examples of such automatically-labeled (LLM-labeled) datasets that can be generated by the LLM are:
Inference:
Example 1: Email Security Classification.
Email=>Spam, because. . . .
   Fraud-Related, because. . . .
   Phishing, because . . .
Example 2: Document Classification.
Document=>Finance-related, because . . .
   Non HR-related, because . . .
   Legal related, because . . .

As indicated in block 170, Model Training can now be performed; such as, by using AutoML or other ML model training tools to create an ML text classification model. The output of this step is an ML model, of Text=>Class. In accordance with some embodiments, the automatically-generated ML model is a classic ML model (e.g., such as CatBoost or category boosting model), that can be run efficiently without necessarily requiring an LLM or a GPU for classifying new text via the ML model.

As indicated at block 180, the ML model that was automatically generated can be deployed and utilized for prediction. For example, the automatically-generated ML model can be used in a “production” computerized environment or in a “real time” environment or an “online” system, to predict (perform, estimate, generate) classification of new or incoming documents/messages; or, the automatically-generated ML model can be used to classify documents/messages in an offline dataset; and so forth.

It is noted that the above-mentioned process can be used for binary classification, as well as for multiclass classification or multinomial classification.

In a demonstrative embodiment, the above-mentioned process may be used to achieve automatic construction of a computerized model for classification of incoming messages as spam/non-spam. For example, a dataset of pre-labeled messages is provided, each message being already pre-labeled as spam or non-spam. The LLM is fed those pre-labeled messages, and performs analysis that generates the supporting reasons for the classification of each of those pre-labeled messages as spam or non-spam. The LLM generates textual reasoning; for example, Message-1 is spam because it includes the term “free money”; Message-2 is spam because it includes the term “click here to become rich today”; Message-3 is spam, deduced the LLM, “because it makes unrealistic promises to get rich within two days by investing five dollars”, and so forth. Similarly, for example, the LLM may determine from analysis of a set of labeled spam messages, that the presence of words or terms (or their equivalents in a natural language), such as “limited-time offer” or “absolutely free” or “click here now” or “guaranteed” or “get rich quick” or “risk-free”, are spam indicators or spam features. The LLM prepares a collected/collated Unified List of reasonings (e.g., spam features or spam indicators or spam characteristics, in this example), and an Instruction Prompt is constructed by the LLM on the basis of those collated reasonings or indicators. When a new, non-labeled message is analyzed, the LLM can use these indicators in the Instruction Prompt to perform the classification; and if a new message is classified as spam, the LLM can provide the presence of particular spam indicators as the reason for its classification (e.g., in contrast with a conventional ML-based spam detection system, that operates as a “black box” and does not provide any such reasoning). Accordingly, the Instruction Prompt may be used by the LLM to classify new, non-labeled, messages as spam/non-spam; and in accordance with some implementations, the fresh LLM-labeled messages can further be used to automatically construct an ML model for binary classification of messages as spam/non-spam.

Similarly, some embodiments may be utilized to automatically construct a system that performs multiclass/multiple-class classification (or tagging, or labeling) of messages or documents; for example, classifying whether a document or a message is “related to Legal”, or “related to Finance”, or “related to HR”, or “related to IT”, and so forth. The LLM can firstly extract indicators/features from a set of already-labeled/pre-labeled/pre-tagged documents or messages, and a collated/collected Unified List can be used as an Instruction Prompt to classify new/newly-arriving/newly-created documents or messages, together with a textual reasoning/support/explanation about the basis of the classification in particular indicators or features.

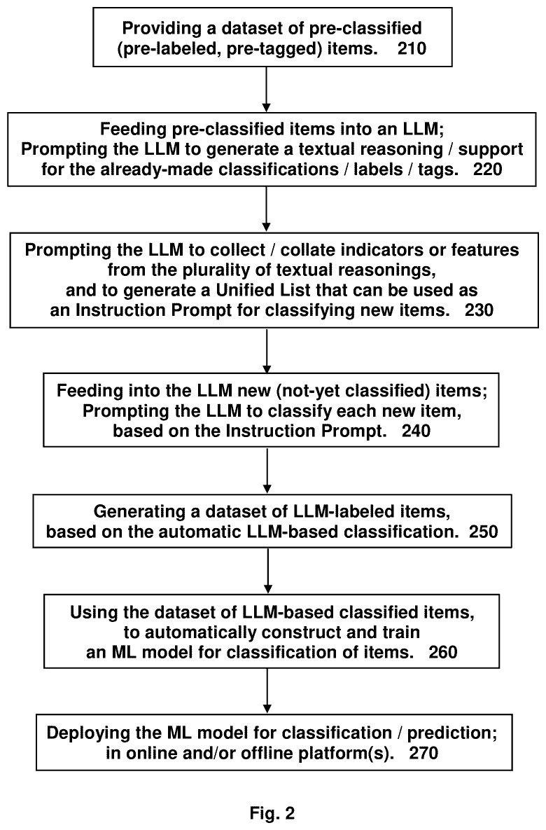

Reference is made to FIG. 2, which is a flow-chart of a computerized method in accordance with some demonstrative embodiments. For example, the computerized method may include the following demonstrative steps.

Step 210, providing a pre-classified (pre-labeled, pre-tagged) dataset of items.

Step 220, feeding pre-classified items into an LLM; and prompting the LLM to generate a textual reasoning/support for the already-made classification/label/tag.

Step 230, prompting the LLM to collect/collate indicators or features from the plurality of textual reasonings, and to generate a Unified List that can be used as an Instruction Prompt for classifying new (not-yet-labeled, not-yet-tagged, not-yet classified) items.

Step 240, feeding into the LLM new items (not-yet-labeled/not-yet-tagged/not-yet classified items); and prompting the LLM to classify each new item, based on the Instruction Prompt that was prepared as described above.

Step 250, generating from said dataset of non-labeled items, a dataset of LLM-labeled items in view of the automatic LLM-based classification of Step 240.

Step 260, using the dataset that contains the LLM-based classified items, to automatically construct and train an ML model for classification of items.

Step 270, deploying the ML model for classification/prediction; for example, in an online platform or a “production” setting or for classifying newly-incoming/newly-created items in real time or in near-real time; and/or, in an offline platform or as a back-end setting or for classifying items in an offline repository; or for other possible deployments of such ML classification model.

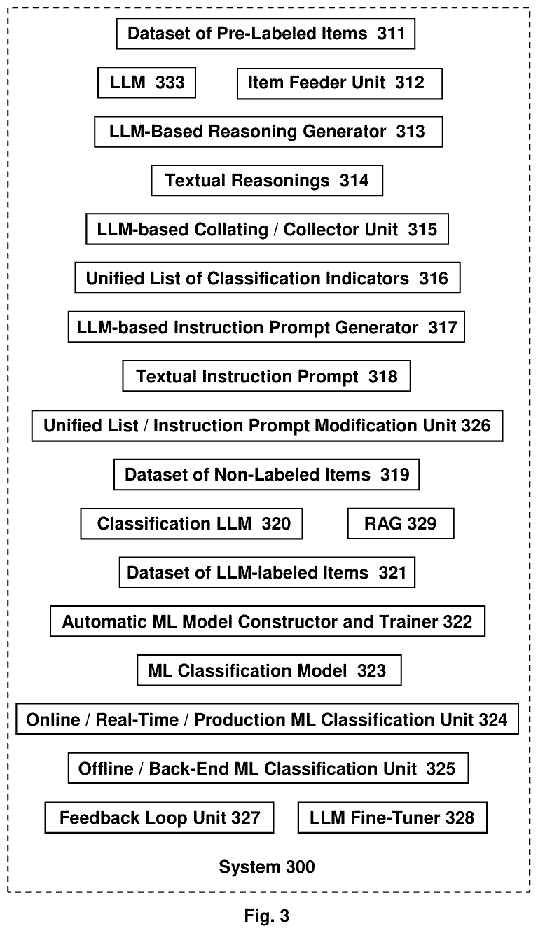

Reference is made to FIG. 3, which is a schematic block-diagram illustration of a computerized system 300, in accordance with some demonstrative embodiments. System 300 may be implemented by using hardware components and/or software components. System 300 may be a centralized or single-location system, or may be a distributed system in which some components may be co-located whereas some components may be remote from each other. Optionally, system 300 may be implemented as a cloud computing system that utilizes remote servers/databases/components, or using client/server architecture or peer-to-peer architecture or distributed architecture or other suitable architectures.

System 300 may comprise a Dataset of Pre-Labeled Items 311. In system 300, a local or remote Large Language Model (LLM) 333 is utilized, or a set or chain or plurality of LLMs may be used. For example, an Item Feeder Unit 312 is configured to feed pre-labeled items an LLM-Based Reasoning Generator 313, and to prompt or command that unit to operate its LLM and to generate textual reasoning that support the pre-labeled classification of each such pre-labeled item. The LLM-Based Reasoning Generator 313 thus generates a plurality of Textual Reasonings 314 that support the pre-labeled classifications. Then, an LLM-based Collating/Collector Unit 315, which may be implemented as an LLM or by utilizing an LLM, collects or collates those Textual Reasonings 314, and generates from them a Unified List of Classification Indicators 316. The same

LLM, or a different LLM that may be referred to as an LLM-based Instruction Prompt Generator 317, generates from the Unified List a Textual Instruction Prompt 318, which is suitable for commanding an LLM to classify a new (not-yet-classified, not yet labeled) item.

A dataset of non-labeled (non-tagged, not-yet-classified) items 319 is provided; and a Classification LLM 320 is now fed (e.g., by the Item Feeder Unit 312) non-labeled items from that dataset 319, and utilizes that Textual Instruction Prompt 318 to perform LLM-based classification of the not-yet-labeled items in that dataset 319; thereby generating a Dataset of LLM-labeled Items 321.

An Automatic ML Model Constructor and Trainer 322 utilizes that Dataset of LLM-labeled Items 321, to construct and train an ML Classification Model 323 for automatic classification of items. The constructed ML Classification Model 323 can then be deployed in a variety of implementations; for example, as an Online/Real-Time/Production ML Classification Unit 324 that performs online or real-time prediction or classification, or as an Offline/Back-End ML Classification Unit 325 that performs offline prediction or classification; and operates to automatically classify new/incoming/freshly-generated/freshly-received items.

Optionally, some implementations may provide the Unified List of indicators/reasonings, and/or the Instruction Prompt, which are textual segments in a natural language (e.g., English), to an independent Reviewing User that can optionally edit or modify the Unified List and/or the Instruction Prompt. For example, prior to deploying the Instruction Prompt towards a dataset of one thousand (or one million) documents, some implementations may be configured to show the Instruction Prompt (or the Unified List) to the Reviewing User, which may be a human user who is proficient in Prompt Engineering or (in some implementation) may be an AI-based unit (e.g., utilizing ML/DN/NN, or another LLM that is specifically trained or retrained or configures to specialize in prompt engineering tasks) that similarly is specifically trained in Prompt Engineering; in order to modify and/or improve the Instruction Prompt. The Reviewing User, whether human or AI-based, can perform modification, remove indicators that appear to be erroneous, remove indicators that appear to be redundant, add new indicators by using synonym words or equivalent phrases, or the like. This may be performed via a Unified List/Instruction Prompt Modification Unit 326, which is an optional component in some implementations. This innovative approach combines the “black box” approach of conventional AI systems, with the unique approach of the present invention in which textual reasonings for pre-labeled classifications are extracted in a natural language and are collated in a manner that enables a Reviewing User (human or AI-based) to further edit or modify the Unified List or the Instruction Prompt.

Optionally, in some embodiments, the system may utilize a Feedback Loop Unit 327 to collect feedback with regard to classifications or labels or tags that were automatically performed, in order to improve the accuracy of subsequent automated classifications. For example, some or most or all automatic classifications in a batch of classifications may be reviewed for correctness, by a Reviewing User which may be a human reviewer or an AI-based/machine-based reviewer that checks the validity or correctness of classifications and provides feedback. In a demonstrative and non-limiting example, the first 50 classifications that are made automatically by the ML classification model, can be reviewed for correctness by such Reviewing User, which may be a human or may be machine-based (e.g., a different LLM that performs classification from scratch of each item in that batch of 50 textual items that are checked for validity or accuracy); and such feedback may be fed back to the system in order to improve or fine-tune subsequent classifications. For example, the Reviewing User may detect or may observe, in the 50 textual items that were classified as Spam, that 6 of those items are email messages that are actually non-spam, and they all have in common a phrase similar to “Are you free for lunch next Tuesday?”, and the Reviewing User may thus deduce that the inclusion of the word “free” has probably caused the LLM (and later the ML model) to incorrectly classify those messages as Spam; and such feedback about the 6 incorrectly-classified messages, and/or a feedback that pin-points the root cause for that mistake, can be fed back to the LLM in order to cause automatic modification of the Unified List and/or the Instruction Prompt; such as, to fine-tune the system to check that the word “free” appears in the text in the context of free-of-charge, and not in the context of free time for a meeting. The LLM can be fine-tuned based on such feedback, by changing its parameters or coefficients or weights or biases; or even by providing such additional feedback as Additional Context that can be added to the Instruction Prompt; e.g., “If the word Free is part of the email message, then please check carefully whether (a) it appears as a part of a phrase that indicates free-of-charge such that no payment is required, and in such case it is indeed a Spam indicator, or (b) it appears as a part of a phrase in which the sender inquires whether the recipient has time available for a meeting, and in such case it is not a Spam indicator”. In some embodiments, optionally, such Feedback Loop Unit 327 may thus be implemented by using an LLM Fine-Tuner Unit 328 for that purpose, and/or by using a Context Augmenting Unit 329 for that purpose, and/or by a Retrieval-Augmented Generation (RAG) Unit 329 that is configured to use such feedback to improve the quality and accuracy of the Instruction Prompt; and/or by commanding the LLM to re-perform one or more of the operations that yielded the dataset of LLM-labeled items that was utilized to train the ML classification model; and/or by re-training the ML classification model based on the updated dataset of LLM-labeled items.

Some embodiments provide an innovative system and method in the field of computerized platform, specifically focusing on the use of Large Language Models (LLM) to enhance and automate the construction of Machine Learning (ML) classification models. This method addresses the growing needs of large organizations that handle vast amounts of data across various departments and seek efficient ways to classify and manage this data accurately. In modern organizational settings, team members frequently interact with a multitude of electronic documents and messages. These interactions generate large volumes of data, which are often complex and varied, ranging from emails and project documents to legal and financial content. Efficiently managing this data is crucial for operational efficiency, security, and data privacy.

In some embodiments, the system leverages a Large Language Model to automatically generate ML classification models. The process begins by feeding pre-labeled textual items into the LLM. These items are already classified into categories such as spam, legal relevance, financial relevance, etc. The LLM then processes these items to generate textual reasonings that validate the pre-assigned labels. These reasonings are compiled into a Unified List of classification indicators or features, which form the basis for an Instruction Prompt. This prompt is used to analyze a new set of unlabeled textual items. By applying the derived Instruction Prompt, the LLM can automatically categorize these new items, effectively training itself to improve its classification accuracy over time.

Some embodiments thus perform Data Analysis and Reasoning Generation: Initially, a dataset of pre-labeled items is analyzed by the LLM. For each item, the LLM generates a textual explanation that supports its classification (e.g., why an item is labeled as spam). This step is critical as it establishes a foundational understanding of features relevant to each category. Then, Indicator Collation is performed: Following the generation of textual reasonings, these explanations are aggregated. This aggregation process involves collating the reasonings per category to form a comprehensive list of indicators that are characteristic of each class. For example, indicators for spam might include phrases like “free money” or “limited time offer”. Then, Instruction Prompt Generation is performed: From the collated indicators, an Instruction Prompt is created for each category. This prompt comprises rules or guidelines that the LLM uses to classify new data. For instance, a message might be classified as spam if it includes specific indicators identified in the spam category.

As the next step in the process, Classification of New Items is performed: New, unlabeled items are then introduced to the system. Using the previously generated Instruction Prompts, the LLM classifies these items into their respective categories based on the identified features and rules. Then, the system creates a new Labeled Dataset: The classified items form a new, labeled dataset, which is then used to train an ML model. This ML classification model can classify items more efficiently using the insights gained from the LLM's initial classifications.

The system is versatile and can be adapted for various applications including email security, document management, and urgent communications management. It can provide various benefits, such as: (1) Enhanced Transparency: Unlike traditional ML models that often act as “black boxes,” this system provides clear, understandable reasons for each classification, increasing trust and ease of verification. (2) Efficiency and Accuracy: By automating the initial classification with high accuracy, the system reduces the need for manual data handling, thereby saving time and reducing errors. (3) Scalability: The system can handle large volumes of data and is scalable across different organizational departments or even different organizations. (4) Flexible Deployment: The ML model developed through this automated process can be deployed in various settings, including real-time online environments or as part of offline data processing systems. This flexibility allows organizations to use the model in a manner that best suits their operational needs. Some embodiments may thus provide an advancement in the use of artificial intelligence for data classification. By integrating LLMs into the process, it not only improves the efficiency and accuracy of data management tasks but also enhances the explainability of automated decisions. The system may transform how organizations handle large datasets of documents or messages or other textual items, making data-driven decisions more reliable and justifiable.

Some embodiments may provide advanced methodology in the domain of digital systems, emphasizing the exploitation of Large Language Models (LLMs) to innovate and streamline the development of Machine Learning (ML) classification frameworks. This technique is designed to meet the complex needs of substantial enterprises that accumulate extensive datasets across varied departments, necessitating refined strategies for precise data categorization and administration. In the digital era, organizational employees frequently engage with a broad array of electronic data, including emails, reports, and messages, which cumulatively produce significant data volumes. This data, often diverse and voluminous, includes sensitive information necessitating meticulous management to ensure efficiency, security, and compliance with privacy standards.

Some embodiments provide a system that utilizes a Large Language Model to facilitate the automatic generation of ML classification frameworks. Initially, this involves inputting pre-sorted textual content into the LLM, which are documents previously categorized under various labels like spam, legal pertinence, or financial relevance. The LLM analyzes these inputs to produce textual justifications or reasonings that affirm the initial categorizations. These justifications or reasonings are then compiled into a Comprehensive List of classification signals or characteristics, which are used to create detailed Instruction Prompts. These prompts guide the LLM in evaluating and categorizing a fresh batch of unlabeled textual data, thereby training the system to enhance its classification precision progressively.

Some embodiments may perform the following demonstrative process. (1) Analytical Review and Justification Production: The system starts with the LLM analyzing a dataset of previously categorized items. It creates detailed textual justifications for each label, setting a base for identifying features pertinent to each classification. (2) Aggregation of Indicators: Subsequent to generating textual justifications, these are aggregated per category to establish a detailed collection of indicators that typify each classification. For instance, identifiers for spam could encompass phrases such as “get rich quick” or “success is guaranteed”. (3) Generation of Instruction Prompts: From the aggregated indicators, detailed Instruction Prompts are formulated. These prompts consist of guidelines that the LLM utilizes to categorize new, unsorted data accurately. (4) Categorization/classification/tagging/labeling of Novel Items: Newly introduced, unlabeled items are processed through the system. Utilizing the Instruction Prompts created earlier, the LLM assigns categories to these items based on the established rules and indicators. (5) Formation of a Labeled Dataset: The items thus categorized create a newly labeled dataset, which is subsequently employed to train an ML model. This model leverages the insights from the LLM's initial classifications to categorize items with greater efficacy. The ML-based classification of documents/messages can be deployed in a variety of ways, and can be adapted to various implementations, including securing email communications, managing document workflows, and prioritizing urgent content. It can deliver several benefits, such as: (A) Improved Clarity and Transparency: The system offers explicit, comprehensible explanations for each decision, enhancing accountability and simplifying validation. (B) Increased Efficiency and Precision: Automation of the initial classification processes reduces manual intervention, thereby enhancing operational speed and minimizing errors. (C) Expandability: The approach is scalable and can be adapted across diverse organizational units or across different enterprises, handling extensive data volumes effectively. (D) Flexible and Modular Deployment: the developed ML model, through this automated process, can be deployed in diverse environments, both in real-time online platforms and in offline data processing systems. This versatility allows organizations to integrate the model seamlessly into their existing operational frameworks.

Some embodiments may utilize or use or provide the following features or components or functionalities, or some of them. (1) Unified List Generation: The system compiles textual reasoning from pre-labeled data into a Unified List of indicators, which serves as a comprehensive repository of features that define each category. This process enhances the precision of classifications and establishes a robust foundation for constructing detailed instruction prompts. (2) Automatic Instruction Prompt Creation: From the Unified List, the system automatically generates Instruction Prompts that embody specific classification rules, streamlining the process of applying these criteria to new, unlabeled datasets and ensuring consistency in classification decisions. (3) Self-Training Capability: By using the Instruction Prompts to classify new items and continuously refining them based on feedback, the system evolves to become more accurate over time, effectively training itself through ongoing operations. (4) Textual Reasoning Extraction: The LLM delves into the context and content of each pre-labeled item to generate textual reasonings that support its classification. This feature allows the system to provide transparent and understandable justifications for each decision. (5) Indicator Collation: The system aggregates the textual reasonings into a structured format, organizing the reasoning by class or category. This aggregation helps in identifying consistent patterns and features that are pivotal for accurate classification. (6) Multi-Class Classification: The system is designed to handle both binary and multi-class classification tasks, making it versatile for various organizational needs, from simple yes/no decisions to complex categorizations across multiple departments. (7) Parallel Processing: optionally, by utilizing multiple LLMs, the system can process and generate textual reasonings in parallel, significantly speeding up the analysis and classification of large datasets. (8) Real-Time Classification: Once trained, the system can classify new documents in real-time, making it ideal for dynamic environments where decisions need to be made swiftly and accurately. (9) Offline and Online Deployment: The ML model can be deployed both offline and online, providing flexibility for businesses to integrate the system in a manner that best fits their operational workflow and data processing needs. (10) Natural Language Explanations: The system generates explanations in natural language, enhancing the transparency and understandability of automated classifications, which is crucial for compliance and auditability. (11) Customizable Classification Frameworks: Organizations can tailor the classification indicators and rules based on specific internal policies or regulatory requirements, ensuring that the system's output aligns with corporate standards and legal constraints. (12) Extensive Data Handling: Designed to manage large volumes of data, the system efficiently processes thousands of documents or messages per hour, catering to the needs of large organizations. (13) Scalable Architecture: The system's architecture supports scalability, allowing it to expand in capacity and functionality as the organization's data processing needs grow. (14) Cloud-Based Integration: The system can optionally be implemented on (or using) cloud platforms, leveraging cloud storage and computing resources to enhance accessibility and reduce on-premise infrastructure costs. (15) Enhanced Data Security: By categorizing sensitive information accurately, such as documents containing Personally Identifiable Information (PII), the system can help organizations enhance their data security measures and comply with privacy regulations.

Some embodiments may optionally provide or use the following surprising or non-intuitive features, or some of them. (1) Self-Optimizing System: The system learns from each classification decision, subtly adjusting its indicators and prompts based on real-time feedback, thus improving without explicit human intervention or traditional iterative training methods. (2) Error Reduction Through Redundancy: Utilizing multiple LLMs in parallel for the same task may reduce errors, as diverse model reasoning enhances accuracy through consensus and error-checking. (3) Bias Detection: By analyzing its own textual reasonings, the system can identify and correct inherent biases in data, leading to fairer classification decisions over time. (4) Decreased Dependency on Data Labels: While initially dependent on pre-labeled data, the system gradually reduces this dependency as it develops the ability to infer labels based on learned textual reasoning patterns. (5) Cross-Domain Adaptability: The system can unexpectedly adapt the basic principles of its classification techniques to different domains (e.g., from spam detection to legal document sorting) without extensive re-training. (6) Negative Feature Utilization: The system can optionally utilize not just the presence but also the absence of certain indicators to refine classifications, leveraging negative data in a constructive manner. (7) Automated Regulatory Compliance: By automatically aligning its classification processes with predefined regulatory requirements, the system can be adapted to ensure compliance with such requirements, reducing the need for manual oversight. (8) Intrinsic Error Reporting: Instead of merely classifying using a “black box” approach, the system identifies and reports potential errors in its own outputs, acting as its own quality control mechanism.

Some embodiments may optionally utilize one or more of the following additional features, to further improve the performance of the system. (1) Multilingual Support: Enabling the system to process and classify documents in multiple natural languages, broadening its applicability across global operations, and ensuring inclusivity in diverse work environments. (2) User Feedback Loop: a mechanism for users to provide feedback on classifications, which the system can use to refine and personalize its learning algorithms, improving accuracy and user satisfaction. (3) Predictive Trend Analysis: Equip the system with the ability to analyze trends from the classified data, predicting future data categorization needs and potential organizational requirements; for example, the system may autonomously notice that 80 percent of incoming email messages are related to the Finance Department, and may recommend to increase the manpower of that department. (4) Emotion Recognition: the system may be further adapted or configured to add emotion recognition or tone recognition capabilities to better understand the tone and intent of communications, allowing for more nuanced classifications; such as, not only as urgent or non-urgent, but rather, “message conveys customer anger” or not, or “message conveys customer dissatisfaction” or not, or “message conveys customer satisfaction” or not, based on emotional cues. (5) Data Anonymization Feature: optionally, some systems may automatically detect and anonymize personal or sensitive information before it is processed for classification, ensuring privacy and compliance with data protection regulations; particularly if an external or cloud-based LLM is utilized. (6) Automated Summary Generation: After classifying documents, automatically generate summaries or abstracts of content, providing quick insights and improving efficiency in document handling processes; and optionally adding a Summary paragraph or a Summary meta-data to processed documents, or writing such summaries into a separate database that can be efficiently sorted, browsed, filtered, or reviewed. (7) Real-time Collaboration Tools: Enable real-time collaboration features where teams can see classifications as they are processed and provide immediate inputs or corrections, fostering a collaborative approach to data handling, and enabling an immediate feedback loop to automated classifications.

Some embodiments may optionally utilize the following components, or some of them: (1) Data Input Interface, which allows users to input data, either manually or automatically, from various sources like databases, emails, or documents, ensuring that the system has a constant flow of information to process. (2) Pre-Labeled Item Repository, which is a storage component that holds datasets which have already been categorized, serving as training material for the system to learn from. (3) Textual Reasoning Generator, which utilizes the LLM to analyze pre-labeled items and generate detailed explanations supporting their classifications, enhancing the system's learning capabilities. (4) Unified List Compiler, which aggregates the generated textual reasonings into a comprehensive list that categorizes and identifies key features and indicators for each class. (5) Instruction Prompt Creator, which constructs detailed instruction prompts from the Unified List, which guide the classification of new, unlabeled items. (6) New Item Feeder, that manages the intake of new, unlabeled items into the system, ensuring they are properly queued for processing according to the generated instruction prompts. (7) Classification Engine, which is the core analytical engine that applies the instruction prompts to new items, categorizing them based on the established rules and indicators. (8) LLM-Based Labeling Unit, which uses the LLM outputs to assign labels to new items, integrating the classification results into a coherent data structure such as a dataset of LLM-labeled textual items. (9) ML Model Trainer, which utilizes the newly classified items to train and refine the ML classification model, ensuring the system improves over time. (10) Data Output Interface, which provides a pathway for sending the processed and classified data to other systems or databases, facilitating further actions or storage. (11) User Interface (UI) or Graphical User Interface (GUI), which allows users to interact with the system, configure settings, and view classifications, enhancing accessibility and usability. (12) Feedback Collection Module, that can optionally gather user feedback on classification accuracy and system performance, which can optionally be used to refine future classifications. (13) Security Module(s), ensures data integrity and confidentiality through encryption, access controls, and other security measures, protecting sensitive information processed by the system. (14) Analytics Dashboard, which can display real-time statistics and analytics about the system's performance, classification accuracy, and other key metrics, aiding in decision-making and system adjustments. (15) Error Detection and Correction Module, that can automatically detect and/or correct errors in data classification, reducing manual intervention and improving system reliability; for example, by utilizing a plurality of LLMs to process the same data-item in parallel, and then selecting the result that won a majority or a consensus from the plurality of LLMs. (16) Resource Management Unit, which monitors and allocates computational resources like CPU/GPU and memory usage, optimizing system performance based on current workloads. (17) Backup and Recovery modules, that maintains system integrity by regularly backing up data and providing a robust recovery mechanism in case of failures. (18) Optionally, an Application Programming Interface (API) Gateway, to facilitate communication between the system and external applications, allowing for seamless integration and data exchange. (19) Real-Time Monitoring System, that continuously monitors system operations, providing alerts and updates to ensure high availability and prompt troubleshooting. (20) Optionally, a Regulatory Compliance Checker, which verifies that all system processes and data handling practices comply with relevant laws and regulations, ensuring legal adherence, preventing PII leakage, complying with HIPAA or financial or banking regulations, or the like. (21) Customization and Configuration Toolset, allowing users to customize classification rules and system settings, adapting the system to specific organizational needs and preferences.

Some embodiments may generate some or all of the following innovative outputs. (1) Contextual Explanations: the system may output detailed explanations for classifications that integrate contextual information, such as time and user activity, making the reasoning more relevant and understandable based on the situation in which the data was used or created. (2) Predictive Categorizations: the system may provide forecasts about potential future categorizations based on trending data patterns and user behaviors, helping organizations anticipate and prepare for future data management needs. (3) Bias Reports: the system may generate reports highlighting any biases detected in the classification process, including how they were addressed, promoting transparency and fairness in automated decisions. (4) Compliance Alerts: the system may automatically produce alerts if data handling or classification processes potentially violate regulatory requirements, aiding in proactive compliance management. (5) Custom Classification Schemas: the system optionally offers tailored classification schemas based on user feedback and specific organizational requirements, allowing for more precise and relevant data sorting. (6) Real-Time Collaboration Annotations: the system optionally creates annotations in a collaborative environment where users can view and interact with classification tags in real time, enhancing teamwork and decision-making. (7) Emotional Tone Assessments: optionally, the system can evaluate and report the emotional tone or mood of textual content, providing insights into the sentiment of communications which can be crucial for customer relationship management and internal communications. (8) Enhanced Security Tags: the system can automatically tag documents with enhanced security classifications based on the presence of sensitive information or PII, ensuring that data protection measures are appropriately applied. (9) Efficiency Metrics: the system may output metrics detailing the system's classification speed, accuracy, and resource usage, offering actionable insights into its operational efficiency. (10) User Interaction Logs: the system may keep and update logs of user interactions with the classification system, including adjustments and feedback, which can be used for auditing user engagement and system responsiveness.

Some embodiments may optionally address, prevent, cure, solve, and/or mitigate various problems or disadvantages or limitations of conventional systems, such as the following. (1) Lack of Transparency in AI Decision-Making: the system of some embodiments provides clear, human-readable explanations for each classification, making the reasoning behind AI decisions accessible and understandable to users, thereby enhancing trust in automated systems. (2) Data Overload: the system of some embodiments provides efficiently processes and categorizes large volumes of data, reducing the burden on human operators and preventing errors that arise from manual data handling. (3) Slow Response Times: the system of some embodiments can provide real-time classification capabilities for incoming messages and/or for newly-created documents, ensuring timely responses to data input which is critical in dynamic business environments where quick decision-making is essential. (4) Data Security Risks: the system of some embodiments identifies and classifies sensitive information automatically, enhancing data security protocols by ensuring that such information is handled and stored appropriately; or can similarly detect spam messages, phishing attacks, fraud-related messages, or other risks. (5) Regulatory Non-Compliance: the system of some embodiments can automatically check compliance with regulations during data processing, alerting users to potential violations and reducing the risk of legal penalties. (6) Inconsistent Data Categorization: the system of some embodiments can standardize the process of data categorization and document categorization across an organization by applying uniform classification rules, ensuring consistency and reliability in how information is organized and retrieved, and removing subjective bias or personal opinion that a human classifier may exhibit. (7) High Operational Costs: some embodiments can reduce the need for extensive manual labor in data classification and analysis, thereby decreasing operational costs associated with human resources. (8) User Resistance to AI Tools: by providing explanations in natural language and allowing for user feedback, the system may increase user acceptance and ease of integration into existing workflows. (9) Bias in AI Models: some embodiments can be configured to detect and report biases in the system's own classification logic, allowing for adjustments that make the AI models fairer and more equitable. (10) Language Barriers: some embodiments can provide multilingual support, enabling the system to process and classify documents in various languages, bridging communication gaps within multinational corporations. (11) Access Control Issues: some embodiments may enhance security and/or may reduce security risks, by classifying documents based on their sensitivity and automatically applying appropriate access controls, preventing unauthorized access. (12) Failure to Leverage Historical Data: some embodiments may utilize historical classification data to improve and refine AI models continuously, ensuring that the system becomes more accurate and effective over time. (13) Lack of Scalability in Traditional Systems: designed to be scalable, the system of some embodiments can handle increasing amounts of data without a loss in performance, making it suitable for growing organizations. (14) Inadequate Error Handling: the system of some embodiments can automatically detect and correct classification errors, reducing the need for manual re-checks and ensuring high accuracy and reliability in data categorization.

Some embodiments may provide a method for classifying data items using a large language model (LLM), comprising: Receiving a dataset of pre-labeled data items; Analyzing each pre-labeled data item with the LLM to generate textual reasonings supporting the classification of each item; Compiling the textual reasonings into a unified list of classification indicators.

Some embodiments may provide a system for automated data classification, comprising: A data input interface to receive new, unlabeled data items; An instruction prompt creator configured to generate classification prompts based on previously compiled classification indicators; A classification engine to apply the instruction prompts to new data items and classify them accordingly.

Some embodiments may provide a computer-implemented method to train a machine learning classification model, comprising: Utilizing a pre-labeled dataset to generate a set of textual reasonings using a large language model; Aggregating the textual reasonings into a unified list of features for each category; Automatically generating an instruction prompt from the unified list, which guides the classification of subsequent new items.

Some embodiments may provide a method for creating an instruction prompt for data classification, comprising: Processing a dataset of pre-labeled items through a large language model to extract textual reasonings; Collating these reasonings into a unified list that characterizes each classification category; Generating an instruction prompt based on the unified list that can be used to classify new, unlabeled data items.

Some embodiments may provide a system for generating and using classification indicators, comprising: An LLM-based reasoning generator that processes pre-labeled data items to generate textual reasonings; A collector unit to aggregate these reasonings and form a unified list of indicators per category; An instruction prompt generator that formulates prompts for classifying new data based on the indicators.

Some embodiments may provide a method for enhancing data classification transparency and accountability, comprising: Generating textual explanations for each classification decision made by a large language model; Providing a user interface that displays both the classification decision and the corresponding textual reasoning to the user; Allowing user feedback on the accuracy and appropriateness of the classification and reasoning.

Some embodiments may provide a Machine Learning training method, comprising: Receiving a set of classified items along with their associated reasoning texts generated by a large language model; Using the classified items and reasoning texts to train a machine learning model to replicate or improve upon these classifications; Deploying the trained model to automatically classify new data items.

Some embodiments may provide a method for real-time data classification in an online environment, comprising: Receiving data items in real-time; Classifying the data items using a previously generated instruction prompt based on a large language model; Outputting the classification results for immediate use within the online environment.

Some embodiments may provide a method for reducing bias in automated classification systems, comprising: Identifying potential biases in textual reasonings generated by a large language model; Adjusting the data input or the model's parameters to mitigate identified biases; Re-evaluating previously classified items using the adjusted model to ensure fairness.

Some embodiments may provide a system for processing multilingual data items, comprising: A language detection module to determine the language of each received data item; A large language model capable of processing data in multiple languages to generate classification reasonings; A classification module that applies language-specific instruction prompts to classify the data items.

Some embodiments may provide a method for automated regulatory compliance monitoring in data classification, comprising: Using a large language model to classify data items according to regulatory requirements; Automatically generating reports that document compliance with these requirements for each classified item; Providing tools for auditors to review compliance through a user interface.

Some embodiments may provide a machine learning model deployment system, comprising: An automatic model constructor and trainer that uses classified items and their reasonings to build a classification model; A deployment unit that integrates the trained model into a production environment for real-time or batch classification; A monitoring interface to track the model's performance and accuracy in the deployed environment.

Some embodiments may provide a method for training a machine learning classification model using a large language model (LLM), comprising: Receiving a dataset of pre-labeled data items; Analyzing each pre-labeled data item with the LLM to generate textual reasonings supporting the classification of each item; Compiling the textual reasonings into a unified list of classification indicators; Utilizing the pre-labeled data items and the corresponding textual reasonings to train a machine learning model to replicate or improve upon these classifications; Deploying the trained machine learning model to automatically classify new data items based on the classifications and reasoning developed from the unified list.

Some embodiments may optionally provide some or all of the above-mentioned functionalities or components, with one or some of the following additional/optional features. (1) In some embodiments, the dataset of pre-labeled data items includes documents, emails, and/or messages. (2) Some embodiments comprise generating an instruction prompt from the unified list, which guides the classification of new data items. (3) In some embodiments, the textual reasonings are generated in natural language, facilitating easier understanding and review. (4) In some embodiments, the method further comprises adjusting the parameters of the large language model based on feedback received on the accuracy of the classifications produced. (5) Some embodiments may use the machine learning model to classify new data items in real-time. (6) In some embodiments, the deployment of the trained machine learning model includes integration into an existing enterprise system for ongoing data classification. (7) Some embodiments may provide a user interface that allows users to interact with and modify the classification indicators in the unified list. (8) Some embodiments further comprise using the unified list to generate multiple instruction prompts for different classification criteria. (9) In some embodiments, wherein the analysis of pre-labeled data items includes identifying keywords or phrases critical for classification. (10) In some embodiments, compiling the textual reasonings into a unified list involves using statistical analysis to determine the most relevant and/or the most frequent and/or the most common reasonings for classification. (11) Some embodiments may further comprise a step of verifying the accuracy of the classifications made by the machine learning model using a separate validation dataset. (12) Some embodiments may further comprise the step of automatically updating the machine learning model when new data becomes available. (13) In some embodiments, the data items are classified into categories such as spam or non-spam, or such as urgent or non-urgent. (14) In some embodiments, the machine learning model is trained to perform binary classification of data items. (15) In some embodiments, the machine learning model is trained to perform multi-class classification of data items. (16) In some embodiments, the pre-labeled data items are derived from a database storing historical organizational data. (17) In some embodiments, the unified list is stored in a cloud-based storage system to allow access across multiple devices. (18) Some embodiments may comprise employing multiple large language models to generate textual reasonings for redundancy and/or for increased accuracy. (19) In some embodiments, the step of deploying the trained machine learning model includes setting up automated regular retraining cycles based on the accumulation of new classified data. (20) In some embodiments, optionally, the method may include steps to anonymize personal information in the data items before processing. (21) In some embodiments, the unified list includes a set of rules or guidelines derived from the textual reasonings, and these rules or guidelines are used to generate the instruction prompt. (22) In some embodiments, the LLM is configured to identify and mitigate biases in the dataset during the generation of textual reasonings. (23) In some embodiments, the method further comprises the step of providing detailed logs of all classifications for audit and compliance review. (24) In some embodiments, the trained machine learning model includes provisions for user feedback to refine its classifications further based on user inputs.

Some embodiments provide a non-transitory storage medium having stored thereon instructions that, when executed by a machine, cause the machine to perform a method as described above and/or herein.

Some embodiments provide a system comprising: one or more hardware processors, configured to execute code; associated with one or more memory units, configured to store data; wherein the one or more hardware processors are configured to perform an automated process or an automated method as described above and/or herein.

Some embodiments provide a computerized method comprising: (a) obtaining a first dataset of pre-labeled textual items (e.g., textual items/messages/documents that were already labeled/classified/tagged/categorized), wherein each of the pre-labeled textual items is already associated with a pre-label; (b) feeding each of said pre-labeled textual items into a Large Language Model (LLM), and prompting the LLM to generate a textual reasoning that supports the pre-label of each said pre-labeled textual item; (c) collating a plurality of textual reasonings generated in step (b), and generating therefrom a textual instruction prompt; (d) obtaining a second dataset of not-yet-labeled textual items; (e) feeding each of said not-yet-labeled textual items into the LLM, and commanding the LLM to utilize said textual instruction prompt and to generate a textual label for each of said not-yet-labeled textual items; (f) collecting textual items, that were labeled by the LLM in step (e), into a third dataset of LLM-labeled textual items; (g) automatically training a Machine Language (ML) classification model of textual items, on said third dataset of LLM-labeled textual items; (h) deploying said ML classification model, that was automatically trained in step (g) on said third dataset of LLM-labeled textual items, in an ML-based classification platform for classification of textual items.

In some embodiments, the LLM is configured to provide textual reasoning that supports binary classification of the pre-labeled textual items; wherein the LLM is configured to perform binary classification, utilizing said textual instruction prompt, of said not-yet-labeled textual items; wherein step (g) comprises training said ML classification model to perform binary classification of not-yet-labeled textual items, based on the third dataset of LLM-labeled textual items.

In some embodiments, the LLM is configured to provide textual reasoning that supports multi-class classification of the pre-labeled textual items; wherein the LLM is configured to perform multi-class classification, utilizing said textual instruction prompt, of said not-yet-labeled textual items; wherein step (g) comprises training said ML classification model to perform multi-class classification of not-yet-labeled textual items, based on the third dataset of LLM-labeled textual items.

In some embodiments, step (h) comprises: deploying said ML classification model, that was automatically trained in step (g) on said third dataset of LLM-labeled textual items, in an online real-time ML-based classification platform for online and real-time classification of newly-created and newly-incoming not-yet-labeled textual items.

In some embodiments, step (h) comprises: deploying said ML classification model, that was automatically trained in step (g) on said third dataset of LLM-labeled textual items, in an offline or back-end ML-based classification platform for offline classification of not-yet-labeled textual items.

In some embodiments, the first dataset comprises textual items that are pre-labeled as spam or non-spam; the LLM is configured to provide textual reasoning that supports binary classification of the pre-labeled textual items as spam or non-spam; the LLM is configured to perform binary classification, utilizing said textual instruction prompt, of said not-yet-labeled textual items, as either spam or non-spam; wherein step (g) comprises training said ML classification model to perform binary classification of not-yet-labeled textual items as either spam or non-spam, based on the third dataset of LLM-labeled textual items.

In some embodiments, the first dataset comprises textual items that are pre-labeled as phishing or non-phishing; the LLM is configured to provide textual reasoning that supports binary classification of the pre-labeled textual items as phishing or non-phishing; the LLM is configured to perform binary classification, utilizing said textual instruction prompt, of said not-yet-labeled textual items, as either phishing or non-phishing; wherein step (g) comprises training said ML classification model to perform binary classification of not-yet-labeled textual items as either phishing or non-phishing, based on the third dataset of LLM-labeled textual items.

In some embodiments, the first dataset comprises textual items that are pre-labeled as legitimate or fraud-related; the LLM is configured to provide textual reasoning that supports binary classification of the pre-labeled textual items as legitimate or fraud-related; the LLM is configured to perform binary classification, utilizing said textual instruction prompt, of said not-yet-labeled textual items, as either legitimate or fraud-related; wherein step (g) comprises training said ML classification model to perform binary classification of not-yet-labeled textual items as either legitimate or fraud-related, based on the third dataset of LLM-labeled textual items.

In some embodiments, the first dataset comprises textual items that are pre-labeled as urgent or non-urgent; the LLM is configured to provide textual reasoning that supports binary classification of the pre-labeled textual items as urgent or non-urgent; the LLM is configured to perform binary classification, utilizing said textual instruction prompt, of said not-yet-labeled textual items, as either urgent or non-urgent; wherein step (g) comprises training said ML classification model to perform binary classification of not-yet-labeled textual items as either urgent or non-urgent, based on the third dataset of LLM-labeled textual items.

In some embodiments, the first dataset comprises textual items that are pre-labeled as containing Personally Identifiable Information (PII) or not containing PII; wherein the LLM is configured to provide textual reasoning that supports binary classification of the pre-labeled textual items as containing PII or not containing PII; wherein the LLM is configured to perform binary classification, utilizing said textual instruction prompt, of said not-yet-labeled textual items, as either containing PII or not containing PII; wherein step (g) comprises training said ML classification model to perform binary classification of not-yet-labeled textual items as either containing PII or not containing PII, based on the third dataset of LLM-labeled textual items.

In some embodiments, the first dataset comprises textual items that are pre-labeled as either: (i) related to Department A in an organization, or (ii) related to Department B in the organization; the LLM is configured to provide textual reasoning that supports binary classification of the pre-labeled textual items as either related to Department A or related to Department B; wherein the LLM is configured to perform binary classification, utilizing said textual instruction prompt, of said not-yet-labeled textual items, as either related to Department A or related to Department B; wherein step (g) comprises training said ML classification model to perform binary classification of not-yet-labeled textual items, as either related to Department A or related to Department B, based on the third dataset of LLM-labeled textual items.

In some embodiments, the first dataset comprises textual items that are pre-labeled as either: (i) related to Department A in an organization, or (ii) related to Department B in the organization, (iii) related to Department C in the organization; the LLM is configured to provide textual reasoning that supports multi-class classification of the pre-labeled textual items as related to Department A or related to Department B or related to Department C; the LLM is configured to perform multi-class classification, utilizing said textual instruction prompt, of said not-yet-labeled textual items, as related to Department A or related to Department B or related to Department C; wherein step (g) comprises training said ML classification model to perform multi-class classification of not-yet-labeled textual items, as related to Department A or related to Department B or related to Department C, based on the third dataset of LLM-labeled textual items.

In some embodiments, the method further comprises: upon generation of the textual instruction prompt in step (c), and prior to feeding of the textual instruction prompt into the LLM in step (e), performing one or more modifications to said textual instruction prompt by a Prompt Engineering expert to improve accuracy or efficiency of the textual instruction prompt.

In some embodiments, performing the one or more modifications to said textual instruction prompt comprises: automatically performing said one or more modifications by an Artificial Intelligence (AI) unit that was pre-trained to specifically excel in automated Prompt Engineering.

In some embodiments, the method further comprises: upon generation of the textual instruction prompt in step (c), and prior to feeding of the textual instruction prompt into the LLM in step (e): displaying to a user an LLM-suggested version of the textual instruction prompt, obtaining user feedback to the LLM-suggested version of the textual instruction prompt, performing modifications to the LLM-suggested version of the textual instruction prompt based on said user feedback, and utilizing in step (e) a modified version of the textual instruction prompt.

In some embodiments, the method further comprises: obtaining Accuracy Feedback about accuracy or inaccuracy of ML-based classifications of textual items that were performed by the ML-based classification platform in step (h); based on said Accuracy Feedback, re-training said ML classification model.

In some embodiments, the re-training of said ML classification model comprises: fine-tuning the LLM based on said Accuracy Feedback; commanding the LLM to re-label textual items in the third dataset that contains LLM-labeled textual items; re-training said ML classification model on an updated version of the third dataset that contains LLM-labeled textual items.

In some embodiments, the re-training of said ML classification model comprises: providing said Accuracy Feedback to the LLM as additional context; commanding the LLM to re-label textual items in the third dataset that contains LLM-labeled textual items; re-training said ML classification model on an updated version of the third dataset that contains LLM-labeled textual items.

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be implemented by using hardware units, software units, processors, CPUs, DSPs, GPUs, integrated circuits (ICs), logic gates, logic units, memory units, storage units, wireless communication modems or transmitters or receivers or transceivers, cellular transceivers, a power source, input units, output units, Operating System (OS), drivers, applications, and/or other suitable components.

Some embodiments may be implemented by using a special-purpose machine or a specific-purpose that is not a generic computer, or by using a non-generic computer or a non-general computer or machine. Such system or device may utilize or may comprise one or more units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented by using code or program code or machine-readable instructions or machine-readable code, which is stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such device to perform a method in accordance with the present invention.

Some embodiments may be utilized with a variety of devices or systems having a touch-screen or a touch-sensitive surface; for example, a smartphone, a cellular phone, a mobile phone, a smart-watch, a tablet, a handheld device, a portable electronic device, a portable gaming device, a portable audio/video player, a Virtual Reality (VR) or Augmented Reality (AR) or Mixed Reality (MR) device or headset or gear, a “kiosk” type device or a vending machine or an Automatic Teller Machine (ATM), a laptop computer, a desktop computer, a vehicular computer or system, a vehicular dashboard, a vehicular touch-screen, or the like.

The system(s) and/or device(s) of some embodiments may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or devices of some embodiments may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with some embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit, a Flash drive), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C #, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, MATLAB, Pascal, HTML, HTML5, CSS, Dart, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a list of reference value(s) or a database of reference values or ranges; a comparison or matching or searching process which searches for matches and/or identical results and/or similar results and/or sufficiently-close results (e.g., within a pre-defined threshold level of similarity; such as, within 5 percent above or below a pre-defined threshold value), among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may comprise, or may be implemented by using, an “app” or application which may be downloaded or obtained from an “app store” or “applications store”, for free or for a fee, or which may be pre-installed on a computing device or electronic device, or which may be transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some embodiments have been illustrated and described herein, many modifications, substitutions, changes, and equivalents may occur to those skilled in the art. Accordingly, the claims are intended to cover all such modifications, substitutions, changes, and equivalents.

What is claimed is:

1. A computerized method comprising:
(a) obtaining a first dataset of pre-labeled textual items,
wherein each of the pre-labeled textual items is already associated with a pre-label;
(b) feeding each of said pre-labeled textual items into a Large Language Model (LLM), and prompting the LLM to generate a textual reasoning that supports the pre-label of each said pre-labeled textual item;
(c) collating a plurality of textual reasonings generated in step (b), and generating therefrom a textual instruction prompt;
(d) obtaining a second dataset of not-yet-labeled textual items;
(e) feeding each of said not-yet-labeled textual items into the LLM, and commanding the LLM to utilize said textual instruction prompt and to generate a textual label for each of said not-yet-labeled textual items;
(f) collecting textual items, that were labeled by the LLM in step (e), into a third dataset of LLM-labeled textual items;
(g) automatically training a Machine Language (ML) classification model of textual items, on said third dataset of LLM-labeled textual items;
(h) deploying said ML classification model, that was automatically trained in step (g) on said third dataset of LLM-labeled textual items, in an ML-based classification platform for classification of textual items.

2. The computerized method of claim 1,
wherein the LLM is configured to provide textual reasoning that supports binary classification of the pre-labeled textual items;
wherein the LLM is configured to perform binary classification, utilizing said textual instruction prompt, of said not-yet-labeled textual items;
wherein step (g) comprises training said ML classification model to perform binary classification of not-yet-labeled textual items, based on the third dataset of LLM-labeled textual items.

3. The computerized method of claim 1,
wherein the LLM is configured to provide textual reasoning that supports multi-class classification of the pre-labeled textual items;
wherein the LLM is configured to perform multi-class classification, utilizing said textual instruction prompt, of said not-yet-labeled textual items;
wherein step (g) comprises training said ML classification model to perform multi-class classification of not-yet-labeled textual items, based on the third dataset of LLM-labeled textual items.

4. The computerized method of claim 1,
wherein step (h) comprises:
deploying said ML classification model, that was automatically trained in step (g) on said third dataset of LLM-labeled textual items, in an online real-time ML-based classification platform for online and real-time classification of newly-created and newly-incoming not-yet-labeled textual items.

5. The computerized method of claim 1,
wherein step (h) comprises:
deploying said ML classification model, that was automatically trained in step (g) on said third dataset of LLM-labeled textual items, in an offline or back-end ML-based classification platform for offline classification of not-yet-labeled textual items.

6. The computerized method of claim 1,
wherein the first dataset comprises textual items that are pre-labeled as spam or non-spam;
wherein the LLM is configured to provide textual reasoning that supports binary classification of the pre-labeled textual items as spam or non-spam;
wherein the LLM is configured to perform binary classification, utilizing said textual instruction prompt, of said not-yet-labeled textual items, as either spam or non-spam;
wherein step (g) comprises training said ML classification model to perform binary classification of not-yet-labeled textual items as either spam or non-spam, based on the third dataset of LLM-labeled textual items.

7. The computerized method of claim 1,
wherein the first dataset comprises textual items that are pre-labeled as phishing or non-phishing;
wherein the LLM is configured to provide textual reasoning that supports binary classification of the pre-labeled textual items as phishing or non-phishing;
wherein the LLM is configured to perform binary classification, utilizing said textual instruction prompt, of said not-yet-labeled textual items, as either phishing or non-phishing;
wherein step (g) comprises training said ML classification model to perform binary classification of not-yet-labeled textual items as either phishing or non-phishing, based on the third dataset of LLM-labeled textual items.

8. The computerized method of claim 1,
wherein the first dataset comprises textual items that are pre-labeled as legitimate or fraud-related;
wherein the LLM is configured to provide textual reasoning that supports binary classification of the pre-labeled textual items as legitimate or fraud-related;
wherein the LLM is configured to perform binary classification, utilizing said textual instruction prompt, of said not-yet-labeled textual items, as either legitimate or fraud-related;
wherein step (g) comprises training said ML classification model to perform binary classification of not-yet-labeled textual items as either legitimate or fraud-related, based on the third dataset of LLM-labeled textual items.

9. The computerized method of claim 1,
wherein the first dataset comprises textual items that are pre-labeled as urgent or non-urgent;
wherein the LLM is configured to provide textual reasoning that supports binary classification of the pre-labeled textual items as urgent or non-urgent;
wherein the LLM is configured to perform binary classification, utilizing said textual instruction prompt, of said not-yet-labeled textual items, as either urgent or non-urgent;
wherein step (g) comprises training said ML classification model to perform binary classification of not-yet-labeled textual items as either urgent or non-urgent, based on the third dataset of LLM-labeled textual items.

10. The computerized method of claim 1,
wherein the first dataset comprises textual items that are pre-labeled as containing Personally Identifiable Information (PII) or not containing PII;
wherein the LLM is configured to provide textual reasoning that supports binary classification of the pre-labeled textual items as containing PII or not containing PII;
wherein the LLM is configured to perform binary classification, utilizing said textual instruction prompt, of said not-yet-labeled textual items, as either containing PII or not containing PII;
wherein step (g) comprises training said ML classification model to perform binary classification of not-yet-labeled textual items as either containing PII or not containing PII, based on the third dataset of LLM-labeled textual items.

11. The computerized method of claim 1,
wherein the first dataset comprises textual items that are pre-labeled as either: (i) related to Department A in an organization, or (ii) related to Department B in the organization;
wherein the LLM is configured to provide textual reasoning that supports binary classification of the pre-labeled textual items as either related to Department A or related to Department B;
wherein the LLM is configured to perform binary classification, utilizing said textual instruction prompt, of said not-yet-labeled textual items, as either related to Department A or related to Department B;
wherein step (g) comprises training said ML classification model to perform binary classification of not-yet-labeled textual items, as either related to Department A or related to Department B, based on the third dataset of LLM-labeled textual items.

12. The computerized method of claim 1,
wherein the first dataset comprises textual items that are pre-labeled as either: (i) related to Department A in an organization, or (ii) related to Department B in the organization, (iii) related to Department C in the organization;
wherein the LLM is configured to provide textual reasoning that supports multi-class classification of the pre-labeled textual items as related to Department A or related to Department B or related to Department C;
wherein the LLM is configured to perform multi-class classification, utilizing said textual instruction prompt, of said not-yet-labeled textual items, as related to Department A or related to Department B or related to Department C;
wherein step (g) comprises training said ML classification model to perform multi-class classification of not-yet-labeled textual items, as related to Department A or related to Department B or related to Department C, based on the third dataset of LLM-labeled textual items.

13. The computerized method of claim 1,
further comprising:
upon generation of the textual instruction prompt in step (c),
and prior to feeding of the textual instruction prompt into the LLM in step (e),
performing one or more modifications to said textual instruction prompt by a Prompt Engineering expert to improve accuracy or efficiency of the textual instruction prompt.

14. The computerized method of claim 13,
wherein performing the one or more modifications to said textual instruction prompt comprises: automatically performing said one or more modifications by an Artificial Intelligence (AI) unit that was pre-trained to specifically excel in automated Prompt Engineering.

15. The computerized method of claim 1,
further comprising:
upon generation of the textual instruction prompt in step (c),
and prior to feeding of the textual instruction prompt into the LLM in step (e),
displaying to a user an LLM-suggested version of the textual instruction prompt,
obtaining user feedback to the LLM-suggested version of the textual instruction prompt,
performing modifications to the LLM-suggested version of the textual instruction prompt based on said user feedback, and utilizing in step (e) a modified version of the textual instruction prompt.

16. The computerized method of claim 1,
further comprising:
obtaining Accuracy Feedback about accuracy or inaccuracy of ML-based classifications of textual items that were performed by the ML-based classification platform in step (h);
based on said Accuracy Feedback, re-training said ML classification model.

17. The computerized method of claim 16,
wherein the re-training of said ML classification model comprises:
fine-tuning the LLM based on said Accuracy Feedback;
commanding the LLM to re-label textual items in the third dataset that contains LLM-labeled textual items;
re-training said ML classification model on an updated version of the third dataset that contains LLM-labeled textual items.

18. The computerized method of claim 16,
wherein the re-training of said ML classification model comprises:
providing said Accuracy Feedback to the LLM as additional context;
commanding the LLM to re-label textual items in the third dataset that contains LLM-labeled textual items;
re-training said ML classification model on an updated version of the third dataset that contains LLM-labeled textual items.

19. A computerized system comprising:
one or more hardware processors that are configured to execute code,
and that are operably associated with one or more memory units that are configured to execute code;
wherein the one or more hardware processors are configured to perform a computerized process comprising:
(a) obtaining a first dataset of pre-labeled textual items,
wherein each of the pre-labeled textual items is already associated with a pre-label;
(b) feeding each of said pre-labeled textual items into a Large Language Model (LLM), and prompting the LLM to generate a textual reasoning that supports the pre-label of each said pre-labeled textual item;
(c) collating a plurality of textual reasonings generated in step (b), and generating therefrom a textual instruction prompt;
(d) obtaining a second dataset of not-yet-labeled textual items;
(e) feeding each of said not-yet-labeled textual items into the LLM, and commanding the LLM to utilize said textual instruction prompt and to generate a textual label for each of said not-yet-labeled textual items;
(f) collecting textual items, that were labeled by the LLM in step (e), into a third dataset of LLM-labeled textual items;
(g) automatically training a Machine Language (ML) classification model of textual items, on said third dataset of LLM-labeled textual items;
(h) deploying said ML classification model, that was automatically trained in step (g) on said third dataset of LLM-labeled textual items, in an ML-based classification platform for classification of textual items.

20. A non-transitory storage medium having stored thereon instructions that, when executed by a machine, cause the machine to perform a method comprising:
(a) obtaining a first dataset of pre-labeled textual items,
wherein each of the pre-labeled textual items is already associated with a pre-label;
(b) feeding each of said pre-labeled textual items into a Large Language Model (LLM), and prompting the LLM to generate a textual reasoning that supports the pre-label of each said pre-labeled textual item;
(c) collating a plurality of textual reasonings generated in step (b), and generating therefrom a textual instruction prompt;
(d) obtaining a second dataset of not-yet-labeled textual items;
(e) feeding each of said not-yet-labeled textual items into the LLM, and commanding the LLM to utilize said textual instruction prompt and to generate a textual label for each of said not-yet-labeled textual items;
(f) collecting textual items, that were labeled by the LLM in step (e), into a third dataset of LLM-labeled textual items;
(g) automatically training a Machine Language (ML) classification model of textual items, on said third dataset of LLM-labeled textual items;
(h) deploying said ML classification model, that was automatically trained in step (g) on said third dataset of LLM-labeled textual items, in an ML-based classification platform for classification of textual items.
